(19) United States
(12) Patent Application Publication
(10) Pub. No.: US 2014/0281159 A1
(43) Pub. Date: Sep. 18, 2014

(54) MEMORY CONTROLLER

(71) Applicant: KABUSHIKI KAISHA TOSHIBA, Minato-ku (JP)

(72) Inventors: Seiichiro Saito, Kawasaki-shi (JP); Kentaro Yoshikawa, Kawasaki-shi (JP); Masatoshi Sato, Kawasaki-shi (JP)

(73) Assignee: KABUSHIKI KAISHA TOSHIBA, Minato-ku (JP)

(21) Appl. No.: 13/957,675

(22) Filed: Aug. 2, 2013

(30) Foreign Application Priority Data
Mar. 18, 2013 (JP) 2013-055010

(51) Int. Cl. G06F 3/06

(52) U.S. Cl. CPC G06F 3/0685; G06F 3/0604; G06F 3/0638
USPC 711/103

(57) ABSTRACT

According to one embodiment, a memory controller includes an address conversion table, an address conversion circuit which executes a conversion of a first logical address for accessing to a primary storage device and a conversion of a second logical address for accessing to a secondary storage device, and a control circuit which is configured to access a nonvolatile memory as the primary storage device by receiving the first logical address, and access the nonvolatile memory as the secondary storage device by receiving the second logical address.

### CROSS-REFERENCE TO RELATED APPLICATIONS

This application is based upon and claims the benefit of priority from Japanese Patent Application No. 2013-055010, filed Mar. 18, 2013, the entire contents of which are incorporated herein by reference.

### FIELD

Embodiments described herein relate generally to a memory controller.

### BACKGROUND

An information processing apparatus as a computer system, for example, a microcomputer, an image processing processor, an audio processing processor, and the like generally includes a main memory as a primary storage device and a storage memory as a secondary storage device.

As the main memory, in general, a DRAM (Dynamic random access memory) is used. Further, as the storage memory, a NAND flash memory is used in many cases because it can be easily assembled in the computer system.

However, providing the two types of memories, i.e., the main memory and storage memory in the information processing apparatus is disadvantageous to reduce cost of the information processing apparatus. Further, the DRAM as the main memory is a volatile memory and has a problem in that data disappears due to an unintentional turn-off of a power supply.

### BRIEF DESCRIPTION OF THE DRAWINGS

FIG. 1 is a view showing an information processing apparatus;

FIG. 2 is a view showing a data write to a secondary storage device;

FIG. 3 is a view showing an address conversion table;

FIG. 4 is a view showing a data read;

FIG. 5 is a view showing an address conversion table;

FIG. 6 and FIG. 7 are views showing a data rewrite in a primary storage device;

FIG. 8 is a view showing an address conversion table;

FIG. 9 is a view showing a data rewrite in the primary storage device;

FIG. 10 is a view showing an address conversion table;

FIG. 11 is a view showing an information processing apparatus;

FIG. 12 to FIG. 14 are views showing a data rewrite in the primary storage device;

FIG. 15 is a view showing initialization;

FIG. 16 is a view showing an address conversion table;

FIG. 17 and FIG. 18 are views showing prohibitions of a data rewrite;

FIG. 19 is a view showing an address conversion table;

FIG. 20 and FIG. 21 are views showing information processing apparatuses;

FIG. 22 is a view showing an access to a primary storage device; and

FIG. 23 and FIG. 24 are views showing address conversion tables.

### DETAILED DESCRIPTION

In general, according to one embodiment, a memory controller comprising: an address conversion table; an address conversion circuit which executes a conversion of a first logical address for accessing to a primary storage device and a conversion of a second logical address for accessing to a secondary storage device; and a control circuit which is configured to access a nonvolatile memory as the primary storage device by receiving the first logical address, and access the nonvolatile memory as the secondary storage device by receiving the second logical address.

An embodiment will be described below referring to drawings.

### 1. BASIC CONCEPT

In the embodiment described below, a memory controller for using a nonvolatile memory such as a NAND flash memory and the like as a primary storage device and as a secondary storage device at the same time will be proposed. That is, a basic concept is to realize an information processing apparatus (computer system) in which a main memory and a storage memory are integrated in one kind of memories.

As described above, using a nonvolatile memory as the primary/secondary storage devices can omit, for example, a DRAM as a main memory. That is, cost can be reduced by reducing the number of parts of the computer system. Further, the use of the nonvolatile memory as the primary storage device can prevent data being used for a job from being erased due to an unintentional turn-off of a power supply.

Further, it is also possible to improve a performance of the system by assembling the DRAM as the main memory and a SRAM (Static random access memory) as a cache memory, and the like in the computer system employing the basic concept.

Further, when the nonvolatile memory is used as the primary/secondary storage devices, it is preferable that an access control method is not changed when viewed from a host. That is, it is preferable that the host can execute an access control assuming that a primary storage device and a secondary storage device exist (without recognizing a type of respective memories) likewise a conventional method.

For the purpose, a nonvolatile memory device (memory system) having a memory controller and a nonvolatile memory controlled thereby is disposed in the information processing apparatus. Different from an existing NAND controller, for example, a SSD (Solid state drive), a memory card, a USB memory, and the like, the memory controller controls a first operation using the nonvolatile memory as the primary storage device and a second operation using the nonvolatile memory as a secondary storage device by a common memory controller, respectively.

With the configuration, since only assembling the memory system described above to a conventional computer system without changing existing hardware and software in the conventional computer system can realize a computer system making use of the basic concept, system development cost can be suppressed.

Further, when the nonvolatile memory is used as the primary/secondary storage devices, data is moved between a primary storage device and a secondary storage device in the same memory (the nonvolatile memory). This means that the number of times of write/erase in the nonvolatile memory is more increased than a nonvolatile memory used only as a secondary storage device or an auxiliary storage device.

Thus, in the computer system employing the basic concept, when, for example, a NAND flash memory whose number of times of write/erase is restricted is used as the nonvolatile memory, a new Wear leveling technology is also proposed to reduce the number of times of data movement (data copy) in the nonvolatile memory accompanying with the first and second operations described above as much as possible.

With the configuration, the number of times of write/erase in the nonvolatile memory can be reduced by using the system, so that a lifetime of the nonvolatile memory whose number of times of write/erase is restricted can be increased.

### 2. INFORMATION PROCESSING APPARATUS

FIG. 1 shows a main portion of the information processing apparatus.

The information processing apparatus (computer system) includes arithmetic operation device (host) 10, nonvolatile memory device 11, and bus 12 for connecting them.

Arithmetic operation device 10 creates a logical address based on a program (software) and reads and writes data.

Nonvolatile memory device (memory system) 11 is used to store data as a primary storage device and a secondary storage device. Nonvolatile memory device 11 includes memory controller 13 and nonvolatile memory 14. Nonvolatile memory 14 is, for example, a NAND flash memory, a MRAM (Magnetic random access memory), a ReRAM (Resistive random access memory), and the like.

Memory controller 13 controls an operation of nonvolatile memory 14 as the primary storage device and the secondary storage device in response to an instruction from arithmetic operation device 10. The operation includes a new operation resulting from the use of nonvolatile memory 14 as the primary storage device or the secondary storage device in addition to a read operation, a write operation, and an erase operation.

Memory controller 13 includes address conversion module 15, nonvolatile memory control interface (I/F) 16, and control circuit 17. Address conversion module 15 includes bus interfaces 18-1, 18-2, address conversion table 19, and address conversion circuit 20.

Nonvolatile memory control interface 16 is connected to nonvolatile memory 14. When, for example, nonvolatile memory 14 includes packages, nonvolatile memory control interface 16 may include channels in correspondence to the packages. Further, when the packages are NAND flash memories, the packages may be SLCs (Single level cells) or may be MLCs (Multi level cells).

Bus interface 18-1 is an interface when data in nonvolatile memory 14 as the primary storage device is accessed. Further, bus interface 18-2 is an interface when data in nonvolatile memory 14 as the secondary storage device is accessed.

Each of bus interfaces 18-1, 18-2 includes terminals for inputting a control signal such as a read/write command and the like or data and terminals for inputting a logical address for reading/writing data.

In the example, nonvolatile memory device 11 includes bus interface 18-1 as the primary storage device and bus interface 18-2 as the secondary storage device. However, nonvolatile memory device 11 may include a common bus interface as the primary storage device and the secondary storage device in place of them.

Address conversion table 19 stores a correspondence relation between a logical address from arithmetic operation device 10 and a physical address of nonvolatile memory 14. Address conversion circuit 20 executes a conversion from the logical address to the physical address based on address conversion table 19.

Control circuit 17 controls the new operation resulting from the use of nonvolatile memory 14 as the primary storage device or the secondary storage device. For example, control circuit 17 updates (rewrites) address conversion table 19 which stores the correspondence relation between the logical address and the physical address. A specific update method of address conversion table 19 will be described in the embodiment.

According to the information processing apparatus described above, the integration of the primary storage device and the secondary storage device to nonvolatile memory device 11 can reduce cost by reducing the number of parts of the computer system. Further, whether nonvolatile memory 14 is used as the primary storage device or uses as the secondary storage device is controlled by memory controller 13 in nonvolatile memory device 11. Accordingly, since arithmetic operation device 10 can process data by existing hardware and software, the system development cost can be suppressed.

### 3. EMBODIMENT

In the embodiment described below, a write/read control method executed by memory controller 13 of FIG. 1 will be described.

### (1) Data Write to Secondary Storage Device

FIG. 2 shows a data write to a secondary storage device.

The data write to the secondary storage device will be described based on an information processing apparatus of FIG. 1 and a flowchart of FIG. 2.

Second logical address LAx for accessing the secondary storage device is input from, for example, arithmetic operation device 10 to address conversion circuit 20 via bus interface 18-2.

Control circuit 17 allocates second logical address LAx to physical address PAz in nonvolatile memory 14 (step ST1). Further, as shown in, for example, FIG. 3, control circuit 17 creates address conversion table 19 in which second logical address LAx is allocated to physical address PAz (step ST2).

Thereafter, control circuit 17 accesses physical address PAz of nonvolatile memory 14 and writes data to physical address PAz (step ST3).

Note that the data write may be executed (step ST3) in parallel with the creation of the address conversion table (step ST2) or may be executed before the creation of the address conversion table (step ST2).

### (2) Data Read

FIG. 4 shows a data read.

The data read will be described based on the information processing apparatus of FIG. 1 and a flowchart of FIG. 4.

First, the data read from the nonvolatile memory as the secondary storage device will be described.

Second logical address LAx for accessing the secondary storage device is input to address conversion circuit 20 from for example, arithmetic operation device 10 via bus interface 18-2. As shown in, for example, FIG. 3, in address conversion table 19, second logical address LAx stores a first state allocated to physical address (first physical address) PAz in nonvolatile memory 14.

Address conversion circuit 20 converts second logical address LAx to physical address PAz in nonvolatile memory 14 based on address conversion table 19 (step ST11).

Thereafter, when it is confirmed that the secondary storage device has been accessed (step ST12), data is neither moved nor copied substantially as the movement or copy of the data from a secondary storage device to a primary storage device, and control circuit 17 allocates logical address (first logical address) LAy for accessing the primary storage device to physical address PAz (step ST13) as shown in, for example, FIG. 5.

Further, control circuit 17 updates address conversion table 19 from the first state described above to a second state in which both second logical address LAx for accessing the secondary storage device and first logical address LAy for accessing the primary storage device are allocated to physical address PAz (step ST14).

With the operation (update of the conversion table), the data is seemingly moved or copied from the secondary storage device to the primary storage device without being moved or copied non-volatile memory 14.

Thereafter, control circuit 17 accesses physical address PAz of nonvolatile memory 14 and reads the data from physical address PAz (step ST15).

Further, control circuit 17 sends first logical address LAy for accessing the primary storage device to a host (step ST16).

Note that the data read (step ST15) may be executed in parallel with the update of address conversion table (step ST13 and ST14) or may be executed before the update of address conversion table (step ST3 and ST4).

Further, logical address LAy may be sent to the host (step ST16) at any time as long as it is sent after first logical address LAy has been allocated (step ST13).

As described above, in the example, when data is read from the secondary storage device, the data is moved or copied substantially from the secondary storage device to the primary storage device only by updating address conversion table 19.

With the operation, the movement or copy of the data in nonvolatile memory 14 as the primary storage device or as the secondary storage device can be reduced, so that a lifetime of, for example, a nonvolatile memory whose number of times of write/erase is restricted can be increased.

Next, the data read from the nonvolatile memory as the primary storage device will be described.

It is assumed that address conversion table 19 has been updated to the second state in which both the second logical address LAx and first logical address LAy had been allocated to physical address PAz as shown in, for example, FIG. 5.

First logical address LAy for accessing the primary storage device is input from, for example, arithmetic operation device 10 to address conversion circuit 20 via bus interface 18-1. Address conversion circuit 20 converts first logical address LAy to physical address PAz in nonvolatile memory 14 based on address conversion table 19 (step ST11).

When the access to the primary storage device has been confirmed (step ST12), control circuit 17 accesses physical address PAz of nonvolatile memory 14 and reads the data from physical address PAz (step ST17).

### (3) Data Rewrite in Primary Storage Device

FIG. 6 shows a first example of a data rewrite in the primary storage device.

The first example of the data rewrite in the information processing apparatus will be described based on the primary storage device of FIG. 1 and a flowchart of FIG. 6. In the example, a case that updated data is written to first logical address LAy will be examined.

First, first logical address LAy for accessing the primary storage device is input from, for example, arithmetic operation device 10 to address conversion circuit 20 via bus interface 18-1. In the case, address conversion circuit 20 converts first logical address LAy to physical address (first physical address) PAz in nonvolatile memory 14 based on address conversion table 19 (step ST21).

Next, it is confirmed whether or not first physical address PAz is allocated also to other different logical address of first logical address LAy (step ST22). That is, it is confirmed whether or not both the first logical address for accessing the primary storage device and the second logical address for accessing the secondary storage device have been allocated to first physical address PAz.

When two first and second logical addresses LAy, LAx have been allocated to physical address PAz (for example, address conversion table 19 is as shown in FIG. 8(a)), data (old data) of first physical address PAz is copied to new physical address (second physical address) PAnew of nonvolatile memory 14 (step ST23).

Further, as shown in, for example, FIG. 8(b), second physical address PAnew is allocated with first logical address LAy for accessing the primary storage device (step ST24).

Further, the data (old data) of second physical address PAnew is rewritten to updated data (step ST25).

With the operation, the updated data is written to second physical address PAnew.

Next, for example, control circuit 17 updates address conversion table 19 from a state of FIG. 8(a) to a state of FIG. 8(b) (step ST26). That is, second logical address LAx is allocated to first physical address PAz as well as first logical address LAy is allocated to second physical address PAnew.

Note that the address conversion table may be updated (step ST26) at any time as long as it is updated after first logical address LAy has been allocated (step ST24).

With the operation, even when the data in the primary storage device and the data in the secondary storage device are stored in physical address PAz (a case shown in FIG. 8(a)), only the data in the primary storage device is rewritten (the updated data is written to second physical address PAnew) and the data in the secondary storage device (the data of first physical address PAz) is protected as it is.

Further, what is meant by the example resides in that when the data in the primary storage device is not rewritten, the data in the primary storage device and the data in the secondary storage device are stored in physical address PAz at all times (while being kept in the state shown in FIG. 8(a)). Accordingly, the number of times of write/erase of nonvolatile memory 14 having the restricted number of times of write/erase is reduced, so that the lifetime of nonvolatile memory 14 can be increased.

Note that also when two logical addresses have been allocated to one physical address and when the data in the secondary storage device has been rewritten, the same operation as that of the example can be executed. That is, the logical address for accessing the secondary storage device is allocated to new physical address and the updated data is written to the new physical address, thereby data can be updated also to the secondary storage device.

In contrast, at step ST22 described above, when the physical address allocated to second logical address LAx for accessing the secondary storage device is different from the first the physical address allocated to first logical address LAy for accessing the primary storage device, the data of first physical address PAz is rewritten (step ST27).

For example, when address conversion table 19 stores a state shown in FIG. 8(b), first logical address LAy is converted to second physical address PAnew. Since second physical address PAnew is different from first physical address PAz in which the data of the secondary storage device is stored, the rewrite of the data of second physical address PAnew results in the rewrite of the data in the primary storage device.

FIG. 7 shows a second example of the data rewrite in the primary storage device.

The second example of the data rewrite in the primary storage device will be described based on the information processing apparatus of FIG. 1 and a flowchart of FIG. 7.

First, logical address (first logical address) LAy for accessing the primary storage device is input from, for example, arithmetic operation device 10 to address conversion circuit 20 via bus interface 18-1. In the case, address conversion circuit 20 converts first logical address LAy to physical address (first physical address) PAz in nonvolatile memory 14 based on address conversion table 19 (step ST31).

Next, it is confirmed whether or not first physical address PAz has been allocated also to other logical address different from first logical address LAy (step ST32). That is, it is confirmed whether or not both the first logical address for accessing the primary storage device and the second logical address for accessing the secondary storage device have been allocated to first physical address PAz.

When two first and second logical addresses LAy, LAx have been allocated to physical address Paz (for example, address conversion table 19 shows a state of FIG. 8(a)), the updated data is written to new physical address (second physical address) PAnew of nonvolatile memory 14 (step ST33).

Next, first logical address LAy for accessing the primary storage device is allocated to second physical address PAnew (step ST34).

Next, for example, control circuit 17 updates address conversion table 19 from the state of FIG. 8(a) to the state of FIG. 8(b) (step ST35). That is, second logical address LAx is allocated to first physical address PAz as well as first logical address LAy is allocated to second physical address PAnew.

With the operation, even when the data in the primary storage device and the data in the secondary storage device are stored in physical address PAz (the state shown in FIG. 8(a)), the data in the primary storage device is rewritten (the updated data is written to new physical address PAnew) and the data in the secondary storage device (data of physical address PAz) is protected as it is.

Note that also when two logical addresses have been allocated to one physical address and when the data in the secondary storage device has been rewritten, the same operation as that of the example can be executed. That is, the updated data is written to the new physical address and the logical address for accessing the secondary storage device is allocated to new physical address, thereby data can be updated also to the secondary storage device.

In contrast, at step ST32 described above, the physical address allocated to second logical address LAx for accessing the secondary storage device is different from first physical address PAz allocated to first logical address LAy for accessing the primary storage device, the data of first physical address PAz is rewritten (step ST36).

When, for example, address conversion table 19 is in the state as shown in FIG. 8(b), first logical address LAy is converted to second physical address PAnew. Since second physical address PAnew is different from first physical address PAz in which the data of the secondary storage device is stored, the rewrite of the data of second physical address PAnew results in the rewrite of the data in the primary storage device.

FIG. 9 shows a third example the data rewrite in the primary storage device.

The third example of the data rewrite in the primary storage device will be described based on the information processing apparatus of FIG. 1 and a flowchart of FIG. 9.

First, logical address (first logical address) LAy for accessing the primary storage device is input from, for example, arithmetic operation device 10 to address conversion circuit 20 via bus interface 18-1. In the case, address conversion circuit 20 converts first logical address LAy to physical address (first physical address) PAz in nonvolatile memory 14 based on address conversion table 19 (step ST41).

Next, it is confirmed whether or not first physical address PAz has been allocated also to other logical address different from first logical address LAy (step ST42). That is, it is confirmed whether or not both the first logical address for accessing the primary storage device and the second logical address for accessing the secondary storage device have been allocated to first physical address PAz.

When two first and second logical addresses LAy, LAx have been allocated to physical address PAz (for example, address conversion table 19 shows the state shown in FIG. 10(a)), the data (old data) of first physical address PAz is copied to new physical address (second physical address) PAnew of nonvolatile memory (step ST43).

Further, as shown in, for example, FIG. 10(b), second logical address LAx for accessing the secondary storage device is allocated to second physical address PAnew (step ST44).

Further, the data (old data) of first physical address PAz is rewritten to the updated data (step ST45).

With the operation, the updated data is written to first physical address PAz.

Next, as shown in, for example, FIGS. 10(a) and 10(b), control circuit 17 updates address conversion table 19 from a state shown in FIG. 10(a) to the state shown in FIG. 10(b) in which first logical address LAy is allocated to first physical address PAz as well as second logical address LAx is allocated to second physical address PAnew (step ST46).

Note that the address conversion table may be updated at any time (step ST46) as long as it is updated after second logical address LAx has been allocated (step ST44).

In contrast, at step ST42 described above, when the physical address allocated to second logical address LAx for accessing the secondary storage device is different from physical address PAz allocated to first logical address LAy for accessing the primary storage device, the data of physical address PAz is rewritten (step ST47).

When, for example, address conversion table 19 stores the state shown in FIG. 10(b), first logical address LAy is converted to first physical address PAz. Since first physical address PAz is different from second physical address PAnew in which the data of the secondary storage device is stored, the rewrite of the data of first physical address PAz results in the rewrite of the data in the primary storage device.

Note that also when two logical addresses have been allocated to one physical address and when the data in the secondary storage device has been rewritten, the same operation as that of the example can be executed. That is, a physical address for accessing the primary storage device to which the same physical address is allocated is allocated to new logical address as well as original data is copied to the new physical address. The write of the updated data to original the physical address can also update the data of the secondary storage device.

### (4) Wear Leveling Operation

A technology for leveling the number of times of write/erase (wear) caused by the data rewrite described above (FIG. 6, FIG. 7, and FIG. 9) will be described.

When a memory whose number of times of write/erase is restricted such as a NAND flash memory is used a nonvolatile memory 14 of FIG. 1 and a particular block (particular physical address) of the memory is intensively used, the particular block is prohibited from being used (namely, the particular block becomes a bad block) and a memory capacity is reduced. Accordingly, when the data rewrite technology described above is employed, it is preferable to employ a new wear leveling operation described below and to increase the lifetime of the nonvolatile memory.

FIG. 11 shows a main portion of the information processing apparatus.

FIG. 11 corresponds to FIG. 1. A feature of the processing apparatus of FIG. 11 resides in that wear leveling circuit 21 is added to the information processing apparatus of FIG. 1 and the other point is the same as the information processing apparatus of FIG. 1. Thus, in FIG. 11, the same elements as those of FIG. 1 are denoted by the same numerals as those of FIG. 1 and a detailed description thereof is omitted.

Wear leveling circuit 21 is disposed in memory controller 13 and levels the number of times of write/erase caused by the data rewrite described above (FIG. 6, FIG. 7, and FIG. 9).

FIG. 12 shows an example to which the wear leveling technology is applied to the data rewrite of FIG. 6.

The wear leveling operation will be described based on the information processing apparatus of FIG. 11 and a flowchart of FIG. 12.

First, likewise FIG. 6, step ST21 and ST22 will be executed.

Next, when two first and second logical addresses LAy, LAx have been allocated to one physical address (first physical address) PAz, the number of times of write/erase of nonvolatile memory 14 to all the physical addresses are referred to (step ST23-1).

The number of times of write/erase of nonvolatile memory 14 to all the physical addresses is stored in, for example, wear leveling circuit 21. Wear leveling circuit 21 determines new physical address (second physical address) PAnew to which the data of first physical address PAz is copied based on the number of times of write/erase of nonvolatile memory 14 to all the physical addresses (step ST23-2).

When, for example, the number of times of write/erase is set to each block, a physical address in a block having the smallest number of times of write/erase is set as second physical address PAnew.

The data of first physical address PAz is copied to second physical address PAnew of nonvolatile memory 14 (step ST23-3).

Thereafter, likewise FIG. 6, steps ST24-ST27 will be executed.

FIG. 13 shows an example in which the wear leveling technology is applied to a data rewrite of FIG. 7.

The wear leveling operation will be described based on the information processing apparatus of FIG. 11 and a flowchart of FIG. 13.

First, likewise FIG. 7, step ST31 and ST32 will be executed.

Next, when two first and second logical addresses LAy, LAx have been allocated to one physical address (first physical address) PAz, the number of times of write/erase of nonvolatile memory 14 to all the physical addresses is referred to (step ST33-1).

The number of times of write/erase of nonvolatile memory 14 to all the physical addresses is stored in, for example, wear leveling circuit 21. Wear leveling circuit 21 determines new physical address (second physical address) PAnew to which the updated data is written based on the number of times of write/erase of nonvolatile memory 14 to all the physical addresses (step ST33-2).

When, for example, the number of times of write/erase is set to each block, a physical address in a block having the smallest number of times of write/erase is set as second physical address PAnew.

Then, the updated data is written to second physical address PAnew of nonvolatile memory 14 (step ST33-3).

Thereafter, likewise FIG. 7, steps ST34-ST36 will be executed.

FIG. 14 shows an example in which the wear leveling technology is applied to a data rewrite of FIG. 9.

The wear leveling operation will be described based on the information processing apparatus of FIG. 11 and a flowchart of FIG. 14.

First, likewise FIG. 9, step ST41 and ST42 will be executed.

Next, when two first and second logical addresses LAy, LAx are allocated to one physical address (first physical address) PAz, the number of times of write/erase of nonvolatile memory 14 to all the physical addresses is referred to (step ST43-1).

The number of times of write/erase of nonvolatile memory 14 to all the physical addresses is stored in, for example, wear leveling circuit 21. Wear leveling circuit 21 determines new physical address (second physical address) PAnew to which the data of first physical address PAz is copied based on the number of times of write/erase of nonvolatile memory 14 to all the physical addresses (step ST43-2).

When, for example, the number of times of write/erase is set to each block, a physical address in a block having the smallest number of times of write/erase is set as second physical address PAnew.

Then, the data of first physical address PAz is copied to new physical address PAnew of nonvolatile memory 14 (step ST43-3).

Thereafter, likewise FIG. 9, steps ST44-ST47 will be executed.

As described above, in the examples, the provision of the wear leveling circuit can level the number of times of write/erase caused by the data rewrite described above (FIG. 6, FIG. 7, and FIG. 9).

Accordingly, when a memory whose number of times of write/erase is restricted such as a NAND flash memory is used as nonvolatile memory 14 of FIG. 1, since the number of times of write/erase of the block (the physical address) in nonvolatile memory 14 can be leveled, the lifetime of nonvolatile memory 14 can be increased.

### (5) Initialization

In the information processing apparatus of FIG. 1 or FIG. 11, arithmetic operation device (host) 10 may instruct nonvolatile memory 14 to initialize the data of a logical address in a particular area. In the case, when the data of a physical address allocated to a logical address to be initialized is actually initialized (erased) each time the initiation is instructed, the number of times of write/erase of nonvolatile memory 14 may be unnecessarily increased.

An initializing operation for solving the subject will be described below.

FIG. 15 shows the initializing operation.

The initializing operation will be described based on the information processing apparatus of FIG. 1 or

FIG. 11 and a flowchart of FIG. 15.

First, arithmetic operation device 10 instructs nonvolatile memory device 11 to execute initialization. That is, a logical address in an area (the secondary storage device) in which the initialization is executed is input from, for example, arithmetic operation device 10 to memory controller 13 via bus interface 18-2.

Further, memory controller 13 checks the logical address in the area in which the initialization is executed (step ST51).

Next, data of the physical address allocated to the logical address to be initialized is set to an invalid data (step ST52). That is, the data of the physical address in non-volatile memory 14 allocated to the logical address to be initialized is not initialized (erased).

when, for example, data of a part of physical addresses in a block is initialized at each time the initialization is required, valid data of remaining physical addresses in the block which are not to be initialized must be moved. This means to write the valid data to a new physical address, which results in an increase of the number of times of write/erase to nonvolatile memory 14.

In contrast, in the initialization of data of a part of physical addresses in a block, when data of a physical address to be initialized in the block is set to invalid data as described above, since valid data of remaining physical addresses in the block which are not to be initialized can be remained as it is, a write to a new physical address does not occur. As a result, an increase of the number of times of write/erase of nonvolatile memory 14 can be suppressed.

Note that it is sufficient to execute an actual initialization (data erase) when, for example, no valid data is included in a block.

Next, a flag, which shows that data of a physical address allocated to a logical address to be initialized has been initialized (invalidated) is set up (step ST53).

For example, as shown in FIG. 16, a flag, by which whether or not data is initialized is determined, is added in address conversion table 19.

The example shows a case that an instruction for initializing data of logical address LA1 is issued from arithmetic operation device 10. In the case, a flag showing that the data of logical address LA1 has been initialized is set to “1”. Further, although data of physical address PA1 allocated to logical address LA1 is not actually initialized, the data is set to an invalid data.

Since logical addresses LA2, LA3 have not been initialized, flags corresponding to them remain “0”. That is, data of physical addresses PA2, PA3 allocated to logical addresses LA2, LA3 are valid data.

Next, it is sent to arithmetic operation device (host) 10 that the initialization has been completed (step ST54).

As described above, in the example, whether or not data of a logical address has been initialized is determined by the flag in address conversion table 19, and it does not matter whether or not data of a physical address in non-volatile memory 14 allocated to the logical address to be initialized has been actually initialize. That is, since it is sufficient to execute the initialization (data erase) of the physical address when, for example, no valid data is included in a block, the number of times of write/erase in nonvolatile memory 14 can be reduced.

Accordingly, when a memory whose number of times of write/erase is restricted such as a NAND flash memory is used as nonvolatile memory 14, since the number of times of write/erase of a block (physical address) in nonvolatile memory 14 can be reduced in response to an instruction of initialization of a logical address, a lifetime of nonvolatile memory 14 can be increased.

### (6) Prohibition of Data Rewrite

An operation for prohibiting a data rewrite in a particular area (primary storage device or secondary storage device) will be described.

In the information processing apparatus of FIG. 1 or FIG. 11, arithmetic operation device (host) 10 may instruct nonvolatile memory 14 to protect data of a logical address in the particular area. In the case, it is necessary to restrict the data rewrite described above (FIG. 6, FIG. 7, and FIG. 9).

The operation for prohibiting the data rewrite in the particular area will be described below.

FIG. 17 shows an operation for setting a prohibition of the data rewrite.

The operation for setting the prohibition of the data rewrite will be described based on the information processing apparatus of FIG. 1 or FIG. 11 and a flowchart of FIG. 17.

First, arithmetic operation device 10 instructs nonvolatile memory device 11 to protect data. That is, a logical address in an area (for example, the secondary storage device) in which a data rewrite is prohibited is input from, for example, arithmetic operation device 10 to memory controller 13 via bus interface 18-2.

Further, memory controller 13 checks the logical address in the area in which the data rewrite is prohibited (step ST61).

Next, address conversion circuit 20 converts a logical address in the area in which the data rewrite is prohibited to a physical address (step ST62).

Finally, a flag for showing that it is prohibited to rewrite data to the physical address is set up (step ST63).

For example, as shown in FIG. 19, a flag for determining whether or not data is protected in address conversion table 19 is added.

The example shows a case that arithmetic operation device 10 instructs to prohibit to rewrite data of logical address LA1. In the case, a flag showing that the data of logical address LA1 is protected is set to “1”. In contrast, since data of logical addresses LA2, LA3 are not protected, flags corresponding to the logical addresses LA2, LA3 remain “0”.

Next, it is sent to arithmetic operation device (host) 10 that the protection of data (prohibition of data rewrite) has been set (step ST64).

FIG. 18 shows an operation for accessing an area in which the data rewrite is prohibited.

An operation for accessing the area in which the data rewrite is prohibited will be described based on the information processing apparatus of FIG. 1 or FIG. 11 and a flowchart of FIG. 18.

First, a logical address is input from, for example, arithmetic operation device 10 to memory controller 13 in nonvolatile memory device 11 via bus interface 18-2. The logical address is converted into a physical address by address conversion circuit 20 (step ST71).

Next, whether or not the data rewrite to the physical address is prohibited is checked (step ST72).

When the data rewrite to the physical address is prohibited, that is, when the data of the physical address is protected, this is sent to arithmetic operation device (host) 10 (step ST73). In the case, the data is not rewritten to the physical address.

In contrast, when the data rewrite to the physical address is not prohibited, that is, when the data of the physical address is not protected, a process goes to steps ST22, ST32, and ST42 of, for example, FIG. 6, FIG. 7, and FIG. 9. Thereafter, the data is rewritten according to the flowcharts of FIG. 6, FIG. 7, and FIG. 9.

According to the example described above, the addition of function for prohibiting the data rewrite in the particular area (primary storage device or secondary storage device) allows to execute the data rewrite described above (FIG. 6, FIG. 7, and FIG. 9) while protecting the data in the particular area.

### (7) Error Correction Circuit

In the information processing apparatus of FIG. 1 or FIG. 11, data is generally read/written from and to nonvolatile memory 14 in a state that an error correction function is added. In the case, it is preferable that an error correction capability to nonvolatile memory 14 as the primary storage device is different from an error correction capability to nonvolatile memory 14 as the secondary storage device.

FIG. 20 shows a main portion of the information processing apparatus.

FIG. 20 corresponds to FIG. 1. A feature of the information processing apparatus of FIG. 20 resides in that first and second error correction circuits (ECC) 22-1, 22-2 are added to the information processing apparatus of FIG. 1, and the other points are the same as those of the information processing apparatus of FIG. 1. Thus, in FIG. 20, the same elements as those of FIG. 1 are denoted by the same numerals as those of FIG. 1 and a detailed description thereof is omitted.

First error correction circuit 22-1 has a capability for correcting data read from nonvolatile memory 14 as the primary storage device. Further, second error correction circuit 22-2 has a capability for correcting data read from nonvolatile memory 14 as the secondary storage device. The capabilities of first and second error correction circuits 22-1, 22-2 are different from each other.

The capabilities of first and second error correction circuits 22-1, 22-2 include the number of bits whose error can be corrected, an error correction time (process time), a power consumption, and the like.

The example has a feature in that the capabilities of first and second error correction circuits 22-1, 22-2 can be independently set.

For example, first error correction circuit 22-1 for correcting data read from nonvolatile memory 14 as the primary storage device is set to such a capability that much importance is attached to the error correction time and the power consumption. In contrast, second error correction circuit 22-2 for correcting data read from nonvolatile memory 14 as the second storage device is set to such a capability that much importance is attached to the number of bits whose error can be corrected.

Note that the capabilities of first and second error correction circuits 22-1, 22-2 can be also changed depending on the years during which they are used, the number of times of write/erase, and the like of nonvolatile memory 14.

In the example, although first error correction circuit 22-1 for the primary storage device and second error correction circuit 22-2 for the secondary storage device are disposed independently, an error correction circuit common to the primary storage device and the secondary storage device may be disposed in place of the above configuration.

In the case, it is preferable that a capability of the error correction circuit is automatically changed depending on whether the nonvolatile memory is used as the primary storage device or used as the secondary storage device.

### (8) Cache Memory

In the information processing apparatus of FIG. 1, FIG. 11, or FIG. 20, it is preferable to move the data the number of times of access to which is very large in the data accessed by nonvolatile memory 14 as the primary storage device to a cache memory (for example, SRAM) from which data can be read at a higher speed than the non-volatile memory 14.

FIG. 21 shows a main portion of an information processing apparatus.

FIG. 21 corresponds to FIG. 1. A feature of the information processing apparatus of FIG. 21 resides in that cache memory 23 is added to the information processing apparatus of FIG. 1, and the other points are the same as those of the information processing apparatus of FIG. 1. Thus, in FIG. 21, the same elements as those of FIG. 1 are denoted by the same numerals as those of FIG. 1 and a detailed description thereof is omitted.

Cache memory 23 temporarily stores the data the number of times of access to which is very large in the data accessed by nonvolatile memory 14 as the primary storage device. When arithmetic operation device (host) 10 instructs to read data, the data is read from cache memory 23 from which the data can be read at a high speed and the data is transferred to arithmetic operation device 10.

FIG. 22 shows a sequence for copying data having a high access frequency to the cache memory.

First, when arithmetic operation device (host) 10 instructs to read data, address conversion circuit 20 converts a logical address to a physical address (step ST81).

Next, it is determined whether or not the data is read by accessing nonvolatile memory (primary or the secondary storage device) 14 (step ST82).

When the data is read by accessing nonvolatile memory 14, the number of times of access to the logical address is incremented (step ST83).

For example, the number of times of access to the logical address is stored in address conversion table 19. That is, as shown in FIG. 23, the number of times of access corresponding to logical address LAy allocated to physical address PAz1 is incremented by 1. The example shows a case that the number of times of access to logical address LAy is set to 8.

Note that, in FIG. 23, logical address LAx allocated to physical address PAz2 shows an access to nonvolatile memory 14 as the secondary storage device.

Next, it is determined whether or not the number of times of access exceeds a threshold value (step ST84).

The threshold value is previously set based on a rule of thumb. For example, when a particular logical address is accessed a predetermined number of times or more in a predetermined period, it is determined that data of the particular logical address has a high access frequency, and the data is moved from the nonvolatile memory (the primary storage device) 14 to cache memory 23 (step ST85).

For example, as shown in FIG. 24, when the number of times of access to logical address LAy (91 times) exceeds the threshold value (8 times), after data of physical address PAz1 allocated to logical address LAy has been copied to physical address PAz3 of cache memory 23, the data of physical address PAz1 is set to an invalid data.

Finally, address conversion table 19 is updated to a state that logical address LAy has been allocated to physical address PAz3 of cache memory 23 (step ST86).

With the operation, data of logical address LAy can be read from cache memory 23 at a high speed from next time.

In contrast, when the number of times of access is equal to or less than the threshold value (for example, 8 times or less), step ST5 and ST6 are not executed and the sequence is finished (step ST84).

Further, when the particular logical address has not been accessed, for example, the predetermined number of times or more in the predetermined period, the number of times of access to the particular logical address may be reset. In the case, an access frequency to the particular logical address can be more accurately determined.

Note that when data is moved from nonvolatile memory 14 to cache memory 23, data is read thereafter by accessing cache memory 23 and is not read by accessing nonvolatile memory 14.

That is, when data is read by accessing cache memory 23, the sequence is finished (step ST82).

As described above, according to the example, the data the number of times of access to which is very large in the data accessed by nonvolatile memory 14 as the primary storage device is copied from nonvolatile memory 14 to cache memory 23. With the operation, the data having the high access frequency can be read from cache memory 23 at a high speed.

### 3. EXAMPLE OF APPLICATION

The embodiment described above can be applied to an overall computer system such as a microcomputer, an image processing processor, an audio processing processor, and the like.

### 4. CONCLUSION

According to the embodiment, the primary storage device and the secondary storage device can be integrated to a kind of the memory.

In the controller of the embodiment, the control circuit may be configured to: set data of a physical address allocated to the first logical address or the second logical address to an invalid data, when data of the first logical address or the second logical address is initialized, and set a flag showing an initialization of data of the first logical address or the second logical address to on.

In addition, the control circuit may be configured to: convert the first logical address or the second logical address to a physical address of the nonvolatile memory by the address conversion circuit, when data of the first logical address or the second logical address is protected, and set a flag showing an inhibition of rewriting data of the physical address to on.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory controller comprising:
an address conversion table;
an address conversion circuit which executes a conversion of a first logical address for accessing to a primary storage device and a conversion of a second logical address for accessing to a secondary storage device; and
a control circuit which is configured to access a nonvolatile memory as the primary storage device by receiving the first logical address, and access the nonvolatile memory as the secondary storage device by receiving the second logical address.

2. The controller of claim 1,
wherein the control circuit is configured to:
convert the second logical address to a first physical address of the nonvolatile memory by the address conversion circuit, when a first state in which the second logical address is allocated to the first physical address is stored by the address conversion table and data is read from the nonvolatile memory as the secondary storage device;
allocate the first logical address to the first physical address; and
update the address conversion table from the first state to a second state in which both of the first and second logical addresses are allocated to the first physical address.

3. The controller of claim 2,
wherein the control circuit is configured to:
send the first logical address allocated to the first physical address to a host.

4. The controller of claim 2,
wherein the control circuit is configured to:
read/write data of the first physical address by the first logical address, when the address conversion table is updated to the second state.

5. The controller of claim 1,
wherein the control circuit is configured to:
convert the first logical address to a first physical address of the nonvolatile memory by the address conversion circuit, when a first state in which both of the first and second logical addresses are allocated to the first physical address is stored by the address conversion table and data of the nonvolatile memory as the primary storage device is rewritten;
write update data to a second physical address of the nonvolatile memory;
allocate the first logical address to the second physical address; and
update the address conversion table from the first state to a second state in which the second logical addresses is allocated to the first physical address and the first logical addresses is allocated to the second physical address.

6. The controller of claim 5,
wherein the control circuit is configured to:
copy data of the first physical address to the second physical address; and
write the update data to the second physical address by rewriting data of the second physical address.

7. The controller of claim 5,
wherein the control circuit is configured to:
send the first logical address allocated to the second physical address to a host.

8. The controller of claim 5,
wherein the control circuit is configured to:
read/write data of the second physical address by the first logical address, when the address conversion table is updated to the second state.

9. The controller of claim 1,
wherein the control circuit is configured to:
convert the first logical address to a first physical address of the nonvolatile memory by the address conversion circuit, when a first state in which both of the first and second logical addresses are allocated to the first physical address is stored by the address conversion table and data of the nonvolatile memory as the primary storage device is rewritten;
copy data of the first physical address to a second physical address of the nonvolatile memory;
allocate the second logical address to the second physical address;
rewrite data of the first physical address; and
update the address conversion table from the first state to a second state in which the first logical addresses is allocated to the first physical address and the second logical addresses is allocated to the second physical address.

10. The controller of claim 9,
wherein the control circuit is configured to:
send the first logical address allocated to the first physical address to a host.

11. The controller of claim 9,
wherein the control circuit is configured to:
read/write data of the first physical address by the first logical address, when the address conversion table is updated to the second state.

12. The controller of claim 1,
wherein the control circuit is configured to:
when a first state in which the first logical address is allocated to a first physical address of the nonvolatile memory is stored by the address conversion table and data of the first physical address is saved to the secondary storage device, copy data of the first physical address to a second physical address of the nonvolatile memory;
allocate the second logical address to the second physical address; and
update the address conversion table from the first state to a second state in which the first logical addresses is allocated to the first physical address and the second logical addresses is allocated to the second physical address.

13. The controller of claim 12,
wherein the control circuit is configured to:
when a third state in which the first logical address is allocated to a third physical address of the nonvolatile memory is stored by the address conversion table, before saving data of the first physical address to the secondary storage device, set data of the third physical address to an invalid data, after saving data of the first physical address to the secondary storage device.

14. The controller of claim 5,
wherein the control circuit is configured to:
select the second physical address of the nonvolatile memory based on a number of write/erase times of each of all physical address of the nonvolatile memory.

15. The controller of claim 9,
wherein the control circuit is configured to:
select the second physical address of the nonvolatile memory based on a number of write/erase times of each of all physical address of the nonvolatile memory.

16. The controller of claim 12,
wherein the control circuit is configured to:
select the second physical address of the nonvolatile memory based on a number of write/erase times of each of all physical address of the nonvolatile memory.

17. The controller of claim 1, further comprising:
a first error correction circuit which corrects data read from the nonvolatile memory as the primary storage device; and
a second error correction circuit which corrects data read from the nonvolatile memory as the secondary storage device,
wherein abilities of the first and second error correction circuits are different from each other.

18. The controller of claim 1, further comprising:
a cache memory which stores volatile data,
wherein the control circuit is configured to:
copy data of a physical address allocated to the first logical address to the cache memory, a number of access times of the first logical address is larger than a threshold value; and
update the address conversion table to a state in which the first logical address is allocated to a physical address of the cache memory.

19. A nonvolatile memory device comprising:
a nonvolatile memory;
a memory controller which controls the nonvolatile memory,
wherein the nonvolatile memory is the nonvolatile memory of claim 1, and the memory controller is the memory controller of claim 1.

20. An information processing apparatus comprising:
a nonvolatile memory device;
an arithmetic device which executes an arithmetic of a first data read from the nonvolatile memory device, and which generates a second data writing to the nonvolatile memory device based on the first data; and
a bus which connects between the nonvolatile memory device and the arithmetic device,
wherein the nonvolatile memory device is the nonvolatile memory device of claim 19, and the arithmetic device is a host which generates the first and second logical addresses of claim 1.
